(19) United States
(12) Patent Application Publication
(10) Pub. No.: US 2004/0240735 A1
(43) Pub. Date: Dec. 2, 2004

(54) Intelligent text selection tool and method of operation

(76) Inventor: Mitchell Medina, New York, NY (US)

Correspondence Address: Jean-Marc Zimmerman, Esq., 226 St. Paul Street, Westfield, NJ, 07090, US

(21) Appl. No.: 10/425,534

(22) Filed: Apr. 29, 2003

(51) Int. Cl. G06K 9/34

(52) U.S. Cl. 382/173

(57) ABSTRACT

An intelligent text selection method is provided that includes the steps of selecting a portion of a graphical document, the portion having graphical text information and non-text graphical information, differentiating the graphical text character information from non-text graphical information within the portion and converting the graphical text information into corresponding character code data.

### FIELD OF THE INVENTION

The present invention pertains to optical character recognition applications of scanned documents and, more particularly, to an intelligent text selection tool that applies text-distinguishing techniques to a selected region of a scanned document to identify the graphical text characters contained within the region and then applies optical character recognition (OCR) techniques to the identified graphical text characters.

### BACKGROUND OF THE INVENTION

Prior art products, such as OmniPage™ from Scansoft Inc., converts graphical text information contained in scanned documents into character code data format using OCR techniques. Often times, however, it is desirable to only convert the graphical text information contained in a portion of a document into character code data. To do so using the prior art techniques, a user typically selects the portion of the document to be converted using a GUI-based selection technique, (e.g., drawing a box around the desired portion using a pointing device—a technique sometimes referred to as rubber-banding), and the graphical text information contained in the selected region is converted into character code data using well-known spot OCR techniques.

One of the drawbacks of retrieving character text from graphical text contained in a portion of a scanned document by applying spot OCR to a region selected using rubber-banding techniques is that it requires the user to precisely select only the desired graphical text and not any other extraneous graphical information. Otherwise, the extraneous graphical information will confound the spot OCR mechanism thereby greatly reducing the accuracy of the character recognition algorithm. Because it can be difficult to precisely select the desired graphical text information and exclude undesired information using the generally available rubber-banding controls, spot OCR techniques are often not effective for converting graphical text information contained in a selected portion of a scanned document into character text.

According, it is desirable to provide a mechanism for more accurately converting graphical text information contained in a portion of a scanned document into character code data.

### SUMMARY OF THE INVENTION

The present invention is directed to overcoming the drawbacks of the prior art. Under the present invention an intelligent text selection method is provided that includes the steps of selecting a portion of a graphical document, the portion having graphical text information and non-text graphical information, distinguishing the graphical text character information from the non-text graphical information within the portion and converting the graphical text information into corresponding character code data.

In an exemplary embodiment, the intelligent text selection method includes the step of differentiating the graphical text information from the non-text graphical information using an edge-based analysis algorithm.

In an exemplary embodiment, the intelligent test selection method includes the step of providing the user with a graphical representation of the text differentiated from the non-text graphical information.

In an exemplary embodiment, the intelligent text selection method includes the step of converting the graphical text information into the character code data using an optical character recognition algorithm.

In an exemplary embodiment, the intelligent text selection method further comprises the step of outputting the character code data.

In an exemplary embodiment, the character code data is output to a location selected from a group including a clipboard application, a memory location and an application program.

In an exemplary embodiment, the intelligent text selection method includes the step of outputting a control code.

Accordingly, a method is provided for more accurately converting graphical text information contained in a portion of a scanned document into character text data.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### BRIEF DESCRIPTION OF THE DRAWINGS

For a fuller understanding of the invention, reference is made to the following description taken in conjunction with the accompanying drawings, in which:

FIG. 1 illustrates a computer system diagram for carrying out the spot optical character recognition (OCR) procedure in accordance with the present invention.

FIG. 2A illustrates an example of a spot demarcated using the intelligent text selection tool.

FIG. 2B illustrates another example of a demarcated spot having non-text graphical background.

FIG. 2C illustrates one embodiment of a graphical representation of text differentiated from the surrounding non-text graphical background.

FIG. 3 illustrates a general flowchart of the intelligent text selection in accordance with the present invention.

FIG. 4 illustrates a general flowchart of the spot OCR output in accordance with present invention.

FIG. 5 illustrates a sample of a spreadsheet of cells for use with the present invention.

### DETAILED DESCRIPTION OF THE INVENTION

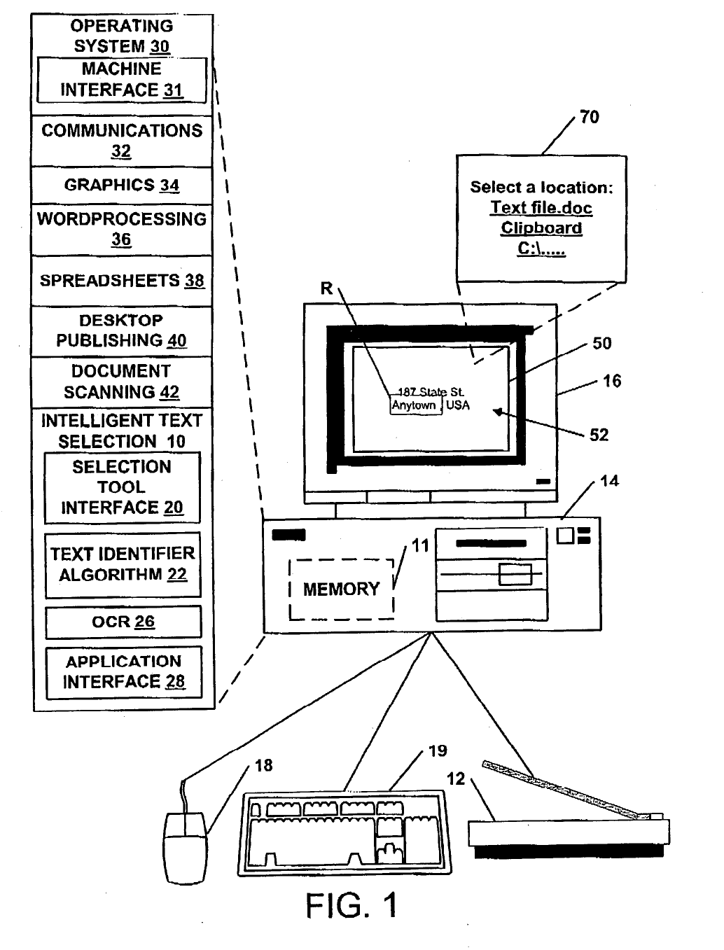

Referring now to FIG. 1, there is shown an intelligent text selection tool 10 of the present invention that provides accurate conversion of graphical text information contained in a portion of a scanned document into character code data. Typically, a document scanning application 42 is used to view scanned images or documents 20. For example, hardcopy documents are scanned via scanner 12 coupled to computer 14 using document scanning application 42 to create an electronic version of the hardcopy document in graphical form. Scanners 12 and their method of operation are well known.

In an exemplary embodiment, the intelligent text selection tool 10 includes a selection tool interface 20 that interfaces with a machine interface 21 of an operating system 30. Using the selection tool interface 20 and machine interface 31, the intelligent text selection tool 10 enables the user to use, for example, a mouse 18 or keyboard 19 to select a region R that includes graphical text information 52 within the scanned document 50 that is displayed on a display screen 16 of computer 14. Optionally, a zoom or magnification option may be provided to or invoked by the user in a bubble around the cursor position in document 50, or otherwise to facilitate selection of region R. Selection of region R or pre-selection of a larger region including R may also be accomplished using image input hardware (for example a hand scanner), which converts only a portion of document 20 to digital image information, as manipulated, interactively controlled, or defined by the user. Region R on document 20 may also be automatically located by the computer system according to previously-defined criteria. As will be described below, under the present invention the user is not required to precisely select in region R only the graphical text information to be converted and exclude all other graphical information from region R

The intelligent text selection tool 10 further includes a text distinguisher algorithm 22 that distinguishes graphical character data from non-text graphical elements that may be adjacent to or embedded in the graphical character data contained in selected region R. Text distinguisher algorithm 22 can distinguish any graphical character data including, by way of non-limiting example, the alphanumeric characters and symbols having a corresponding ASCII code (American Standard Code for Information Interchange). Text distinguisher algorithm 22 may apply any known techniques for distinguishing graphical text embedded within non-text graphics including, by way of non-limiting example, an edge recognition algorithm as described in “Text Identification to Complex Background Using SWM,” by Chen et al., copyright 2001, IEEE. Other algorithms which may be applied include deskew, despeckle, contour-finding, sharpening filters of various types, white space analysis, form field delimiter removal, and others as known to those skilled in the art or developed by them. In the present invention, such algorithms are applied in the text selection tool itself, providing better input for enhanced recognition of the text embedded in region R which is of interest to the user.

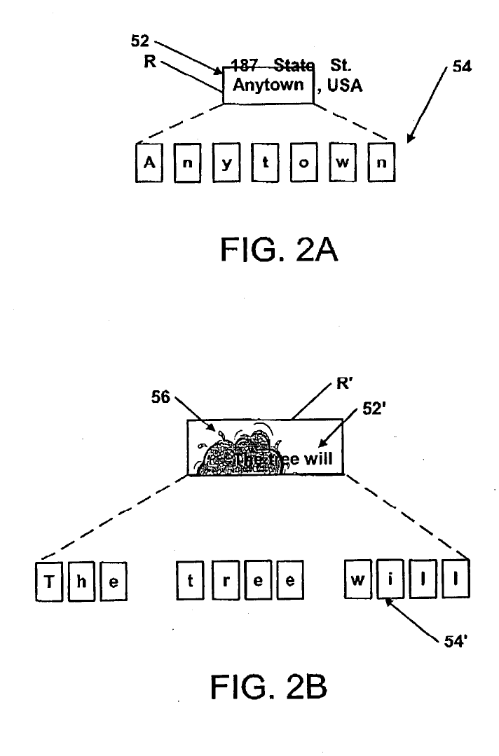

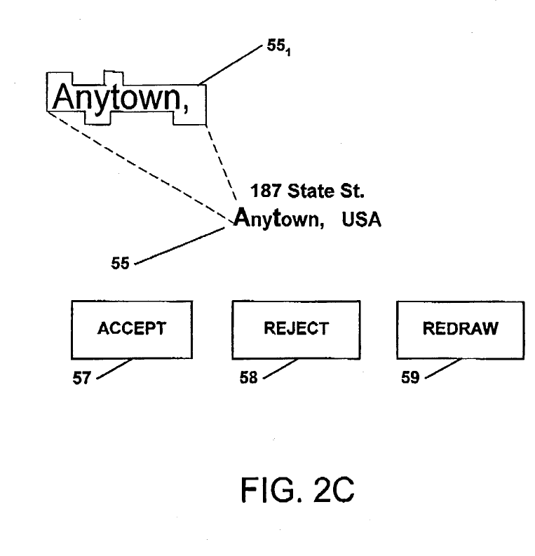

Referring now to FIG. 2A, there is shown an example describing the distinguishing of embedded graphical text using the text distinguisher algorithm 22 of intelligent text selection tool 10. In the example shown in FIG. 2A, due to the inaccuracy of the existing rubber banding techniques, the selection of “Anytown” in the demarcated region R also includes portions of the graphical characters that are adjacent to the selected graphical text (e.g. the lower portion of the “187 St” graphical characters). (Such portion will hereinafter be referred to as “extraneous matter”). The text distinguisher algorithm 22 recognizes the graphical text characters 54 (“Anytown”) and discards the extraneous matter.

Referring now to FIG. 2B, there is shown an example of the text distinguisher algorithm 22 distinguishing graphical text contained in a selected region R′ that also includes a non-text graphical background 56. Here too the text distinguisher algorithm 22 distinguishes the individual text characters 54′ from the non-text graphical background within the demarcated region R′ and discards the non-text graphical background as extraneous matter. Thus, the text distinguisher algorithm 22 differentiates the graphical text information from the non-text graphical information contained in region R so that the accuracy of the character recognition of the graphical text information is improved.

Optionally but helpfully, the intelligent text selection tool 10 can provide a graphical representation to the user of text that it has differentiated from non-text graphical information in Region R. This graphical representation should be distinct from the graphical representation provided to the user by the system of image information selected but not text-differentiated by the intelligent text selection tool (the rubber-band in existing Windows systems). FIG. 2C illustrates one possible but non-limitative distinctive graphical representation according to the invention, called “skylining” for convenience. The “skyline” 55 follows the contours of the selected and differentiated text 54 within region R and displays it on the monitor in a different color, in its graphical context as illustrated in the present Figure, or in the alternative, outside of its context, as in FIGS. 2A and 2B.

The user may be given the opportunity to confirm, reject or redraw the text region identified by the intelligent text-differentiation tool simultaneous with its display, or subsequent to it. This option is represented in FIG. 2C by means of the buttons 57, 58 and 59. Zoom or magnification capabilities (as non-limitatively illustrated by enlarged “skyline” 55₁) may be provided to the user to facilitate the confirmation decision. In one embodiment, the user may activate a free-hand drawing tool (for example, using a menu option accessed by action of the right button on the mouse) to more precisely delineate the correct boundaries of the text region. Various types of pre-set boundary delimiters may be similarly accessed, such as horizontal and vertical lines, or shapes such as boxes, circles, triangles or any other useful option.

The intelligent text selection tool 10 includes or interoperates with an OCR application 26 that converts the graphical text information distinguished by text distinguisher algorithm 22 into character code data. The intelligent text selection tool 10 also includes or interoperates with an application interface 28 that receives the converted character code data and transmits the character code data to other applications resident on computer 14. For example, application interface 28 may communicate the converted character code data to an operation system such as Windows® 98, Windows® ME, Windows® 2000, etc., a graphics program 34, a word processing program 36 such as MS Word™ and Wordperfect™, a spreadsheet program 38 such as Excel™, and desktop publishing software 40. In addition, application interface 28 may communicate the converted character code data to applications not resident on computer 14 by providing the data to a communication application 32 that in turn communicates the data to an application running on any other device using known communications techniques such as, by way of non-limiting example, the Internet.

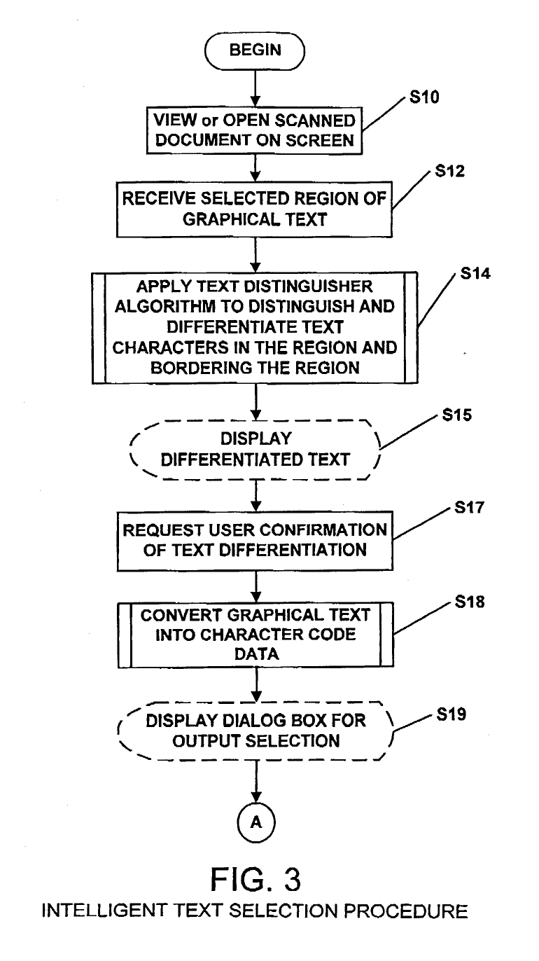

Referring now to FIGS. 1 and 3, the operation of the intelligent text selection tool 10 will now be described. Initially, at Step S10 all or part of a scanned document 50 in graphical form is scanned and viewed, or opened on the screen 16 (for example, by opening the document scanning application 42, or by opening stored scanned image 50). Step S10 is followed by Step S12 where the user selects region R containing the graphical text information 52 the user desires to convert to character code data. Next, in Step S14, the text distinguisher algorithm 22 is applied to the selected region R to distinguish the graphical text information 52 that may be embedded in or directly adjacent to non-text graphical information. In Step S15, the results of text differentiation as performed by the tool may be displayed to the user using a distinctive graphical metaphor such as “skylining”. Further, the user may be given the opportunity to confirm, reject or redraw the results of text-differentiation in step S17. Next, in Step S18, the distinguished graphical text is converted into character code data by OCR application 26.

In the exemplary embodiment, Step S18 is followed by Step S19 wherein a dialog box 70 is displayed querying the user to select the location where the character code data should be inserted. The location information may be provided in any suitable format for identifying the application or location to which the character code data is to be sent. In an exemplary embodiment, the dialog box 70 provides the user a list of open applications and locations that are available for receiving the character code data. The dialog box 70 may also list the cursor position in at least one open application at which the character code data will be inserted. In addition, the tool bar and drop-down menus for the intelligent text selection tool 10 may also provide such capability.

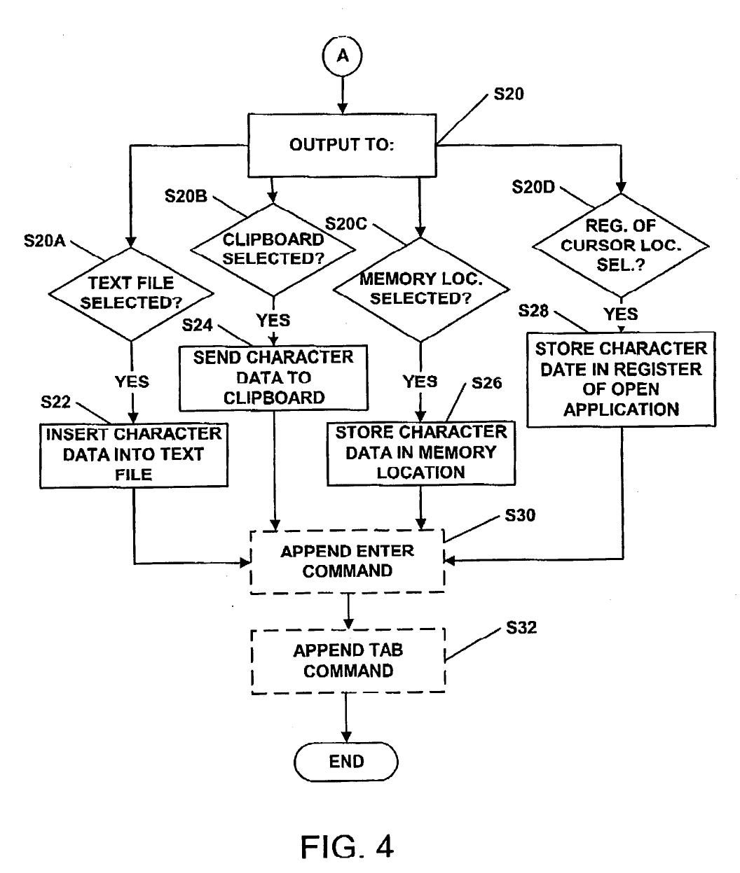

Referring now to FIG. 4, the process by which the application interface 28 outputs character code data according to an exemplary embodiment, is described. At the user's option, the intelligent text selection tool 10 may output the converted character code data extracted/recognized from the selected region R into a text file such as, by way of non-limiting example, a word processing application file 36, a clipboard application or a location in memory 11 maintained by the operating system application 30 or may output the character code data to a cursor location within a particular application. Once the user has made the desired location selection, at Steps S20 and S20a a determination is made whether the user has selected that the character code data be entered into a text file, such as in a wordprocessing application 36. If the determination is “YES” at Step S20a, the character code data is inserted into the text file at Step S22. Thereafter, the character code data may be displayed to the user via screen 16 and may be further modified by the user within the capabilities of the wordprocessing application 36.

At Steps S20 and S20b a determination is made whether the user has selected that the character code data be entered into a clipboard. If the determination is “YES” at Step S20b, the character code data is inserted into the clipboard at Step S24. Thereafter, the character code data can be inserted by the user into other applications using the clipboard application.

At Steps S20 and S20c a determination is made whether the user has selected the character code data to be stored in a location in memory 11 of computer 14. If the determination is “YES” at Step S20c, the character code data is inserted into the location of memory 11 at Step S26. Thereafter, the character code data can be later retrieved from the location of memory using any suitable application.

At Steps S20 and S20d a determination is made whether the user has selected the character code data to be entered at a particular cursor location of an application such as, for example, a particular cell in spreadsheet application 38. If the determination is “YES” at Step S20d, the character code data is inserted at the cursor location at Step S28. In an exemplary embodiment, the application interface 28 automatically appends a control character (such as, by way of example “Enter,” “Tab” “Double Click”) at Step S30 thereby adjusting the location in the application at which a future insertion of character code data occurs.

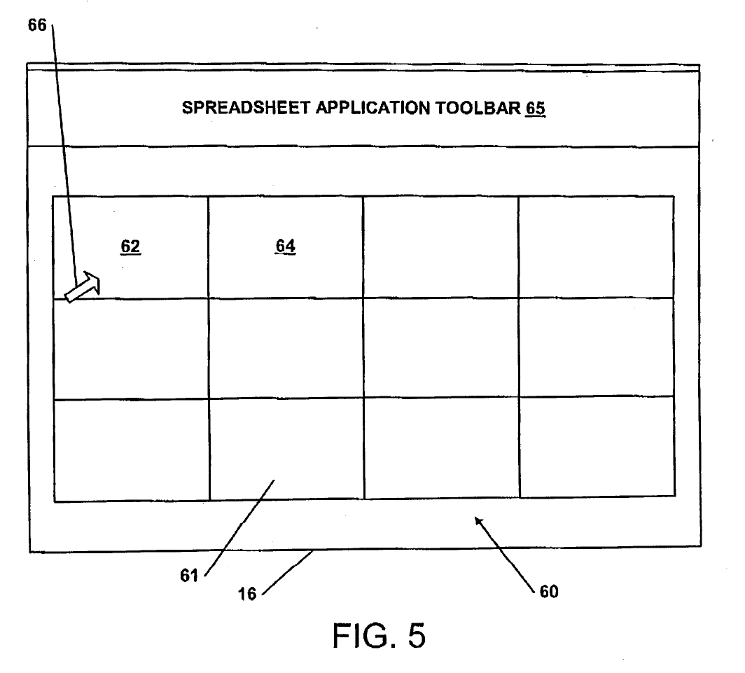

Referring now to FIG. 5, there is shown a spreadsheet 60 of spreadsheet application 38 having a plurality of cells 61 that may be used for receiving character code data from application interface 28 of intelligent selection tool 10. With reference to Steps S28, S30 and S32, character code data is placed in cell 62 (pointed to by cursor 66) by application interface 28 and application interface 28 transmits an “Enter” command or equivalent (at Step S30) to cause spreadsheet application 38 to accept the character code data in cell 62. Application interface 28 may then transmit to spreadsheet program 38 a “Tab” command or equivalent so that the cursor location in spreadsheet 60 is advanced to cell 64 for receiving future character code data.

In an exemplary embodiment, the intelligent text selection tool 10 can be accessed within any open application so that a user may apply the intelligent text selection tool 10 to accurately extract character code data from a graphical potion of any document.

Accordingly, an intelligent text selection tool is provided that enables accurate conversion of graphical text information contained in a portion of a scanned document (or graphic) selected by a user into character code data even though the selected portion contains non-text graphical information. Furthermore, the intelligent text selection tool may output the converted character code data to any application or location, as specified by the user.

A number of embodiments of the present invention have been described. Nevertheless, it will be understood that various modifications may be made without departing from the spirit and scope of the invention. Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, Oracle and DB2, as a platform for implementing the present invention. Also, computer devices may execute an operating system such as Microsoft Windows™, Unix™, or Apple Mac OS™, as well as software applications, such as a JAVA program or a web browser. Computers devices can include a processor, RAM and/or ROM memory, a display capability, an input device and hard disk or other relatively permanent storage. Accordingly, other embodiments are within the scope of the following claims.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

What is claimed is:

1. An intelligent text selection tool, comprising:
means for selecting a portion of a graphical document, said portion having graphical text information and non-text graphical information;
means for distinguishing said graphical text character information from said non-text graphical information within said portion; and
means for converting said graphical text information into corresponding character code data.

2. The intelligent text selection tool according to claim 1, wherein said portion of said graphical document is selected using a device contained in the group including a mouse and a keyboard.

3. The intelligent text selection tool according to claim 1, wherein the distinguishing means applies edge recognition means to differentiate said graphical text information from said non-text graphical information.

4. The intelligent text selection tool according to claim 1, wherein the distinguishing means applies deskew means to differentiate said graphical text information from said non-text graphical information.

5. The intelligent text selection tool according to claim 1, wherein the distinguishing means applies despeckle means to differentiate said graphical text information from said non-text graphical information.

6. The intelligent text selection tool according to claim 1, wherein the distinguishing means applies contour-finding means to differentiate said graphical text information from said non-text graphical information.

7. The intelligent text selection tool according to claim 1, wherein the distinguishing means applies sharpening means to differentiate said graphical text information from said non-text graphical information.

8. The intelligent text selection tool according to claim 1, wherein the distinguishing means applies white-space analysis means to differentiate said graphical text information from said non-text graphical information.

9. The intelligent text selection tool according to claim 1, wherein the distinguishing means applies form-field delimiter removal means to differentiate said graphical text information from said non-text graphical information.

10. The intelligent text selection tool according to claim 1, wherein the distinguishing means applies one or more text-differentiating means to separate graphical text information from said non-text graphical information;
further comprising means to provide the user with a distinctive graphical representation of the differentiated graphical text information.

11. The intelligent text selection tool according to claim 10, further comprising means for at least one of user confirmation, user rejection and user correction of the differentiated graphical text information.

12. The intelligent text selection tool according to claim 10, wherein the converting means applies an optical character recognition algorithm to convert said graphical text information into said character code data.

13. The intelligent text selection tool according to claim 12, further comprising a means for outputting the character code data into a text file.

14. The intelligent text selection tool according to claim 12, further comprising a means for outputting the character code data into a clipboard application.

15. The intelligent text selection tool according to claim 12, further comprising a means for outputting the character code data into a memory location.

16. The intelligent text selection tool according to claim 12, further comprising a means for outputting the character code data into an application program.

17. The intelligent text selection tool according to claim 12, further comprising a means for outputting a control code.

18. The intelligent text selection tool according to claim 12, wherein the character code data is in American Standard Code for Information Interchange (ASCII) format.

19. An intelligent text selection method, comprising the steps of:
selecting a portion of a graphical document, said portion having graphical text information and non-text graphical information; and
distinguishing said graphical text character information from non-text graphical information within said portion for converting said graphical text information into corresponding character code data.

20. The intelligent text selection method according to claim 19, wherein the distinguishing step includes the step of:
differentiating said graphical text information from said non-text graphical information using edge recognition.

21. The intelligent text selection method according to claim 19, wherein the distinguishing step includes the step of:
differentiating said graphical text information from said non-text graphical information using deskew.

22. The intelligent text selection method according to claim 19, wherein the distinguishing step includes the step of:
differentiating said graphical text information from said non-text graphical information using despeckle.

23. The intelligent text selection method according to claim 19, wherein the distinguishing step includes the step of:
differentiating said graphical text information from said non-text graphical information using contour-finding.

24. The intelligent text selection method according to claim 19, wherein the distinguishing step includes the step of:
differentiating said graphical text information from said non-text graphical information using sharpening.

25. The intelligent text selection method according to claim 19, wherein the distinguishing step includes the step of:
differentiating said graphical text information from said non-text graphical information using white-space analysis.

26. The intelligent text selection method according to claim 19, wherein the distinguishing step includes the step of:
differentiating said graphical text information from said non-text graphical information using form-field delimiter removal.

27. The intelligent text selection method according to claim 19, wherein the distinguishing step includes:
differentiating said graphical text information from said non-text graphical information using one or more text-distinguishing steps;
said method also including the step of providing the user with a distinctive graphical representation of the differentiated graphical text information.

28. The intelligent text selection method according to claim 27, further comprising the step of allowing for at least one of user confirmation, user rejection and user correction of the differentiated graphical text information.

29. The intelligent text selection method according to claim 27, wherein the converting step includes the step of:
converting said graphical text information into said character code data using an optical character recognition algorithm.

30. The intelligent text selection method according to claim 29, further comprising the step of:
outputting the character code data.

31. The intelligent text selection method according to claim 30, wherein said character code data is output to a location selected from a group including a clipboard application, a memory location and an application program.

32. The intelligent text selection method according to claim 31, wherein the outputting step includes the step of:
outputting a control code.

33. Computer executable program code residing on a computer-readable medium, the program code implementing a tool for causing the computer to select a portion of a graphical document, said portion having graphical text information and non-text graphical information;
distinguish said graphical text character information from non-text graphical information within said portion; and
convert said graphical text information into corresponding character code data.

34. The computer executable program according to claim 33, wherein the program code additionally causes the computer to:
differentiate said graphical text information from said non-text graphical information using an edge recognition algorithm.

34. The computer executable program according to claim 33, wherein the program code additionally causes the computer to:
differentiate said graphical text information from said non-text graphical information using a deskew algorithm.

35. The computer executable program according to claim 33, wherein the program code additionally causes the computer to:
differentiate said graphical text information from said non-text graphical information using a despeckle algorithm.

36. The computer executable program according to claim 33, wherein the program code additionally causes the computer to:
differentiate said graphical text information from said non-text graphical information using a contour-finding algorithm.

37. The computer executable program according to claim 33, wherein the program code additionally causes the computer to:
differentiate said graphical text information from said non-text graphical information using a sharpening algorithm.

38. The computer executable program according to claim 33, wherein the program code additionally causes the computer to:
differentiate said graphical text information from said non-text graphical information using a white-space analysis algorithm.

39. The computer executable program according to claim 33, wherein the program code additionally causes the computer to:
differentiate said graphical text information from said non-text graphical information using a form-field delimiter removal algorithm.

40. The computer executable program according to claim 33, wherein the program code additionally causes the computer to:
differentiate said graphical text information from said non-text graphical information using one or more text-differentiating algorithms; and
to provide the user with a distinctive graphical representation of the differentiated graphical text information.

41. The intelligent text selection tool according to claim 40, wherein the program code additionally causes the computer to provide at least one of the options of user confirmation, user rejection and user correction of the differentiated graphical text information.

42. The computer executable program according to claim 40, wherein the program code additionally causes the computer to:
convert said graphical text information into said character code data using an optical character recognition algorithm.

43. The computer executable program according to claim 42, wherein the program code additionally causes the computer to:
output the character code data to a location selected from a group including a clipboard application, a memory location and an application program.

44. The computer executable program according to claim 43, wherein the program code additionally causes the computer to:
output a control code.
